(19) United States
(12) Patent Application Publication
(10) Pub. No.: US 2002/0165846 A1
(43) Pub. Date: Nov. 7, 2002

(54) Personal internet portal

(76) Inventors: Eric Richer, Repentigny (CA); Nicolas Fournier, Lasalle (CA); Pierre-Luc Jodoin, Laval (CA); Robert-Claude Maltais, Repentigny (CA); Gerald Host, Montreal (CA)

Correspondence Address: ERICSSON RESEARCH CANADA, 8400 DECARIE BLVD., MONTREAL, QC, H4P 2N2, CA

(21) Appl. No.: 09/682,738

(22) Filed: Oct. 11, 2001

Related U.S. Application Data
(60) Provisional application No. 60/287,734, filed on May 2, 2001.

(51) Int. Cl. G06F 7/00

(52) U.S. Cl. 707/1

(57) ABSTRACT

A personal portal in a data communications network that comprises a number of sites. The personal portal comprises a user profile applicable all over the network and a number of context profiles applicable within a certain site. The user profile comprises a private part accessible only by the user, and a public part accessible to the public. Each context profile may comprise personal information, personal settings, and access policies. As parts of the personal portal may be accessible and downloaded by other users, there is also provided a method and a system for keeping the downloaded profiles up to date. There is also provided a profile storage.

### CROSS REFERENCE TO RELATED APPLICATIONS

PRIORITY STATEMENT UNDER 35 U.S.C. 119(e) & 37 C.F.R.S.1.78. This non-provisional patent application claims priority based upon the prior U.S. provisional patent application entitled ““Software Deployment, Accounting and Personal Portal””, application No. 60/287,734 filed May 2, 2001, in the name of GONTHIER Jean-Charles, RICHER Eric, HOST Gerald, JODOIN Pierre-Luc, FOURNIER Nicolas, MALTAIS Robert Claude, VAN BUNNINGEN Thomas, HARNOIS Serge, WALLNER Sabine, BRASK Patrik.

### BACKGROUND OF INVENTION

1. Technical Field of the Invention

The present invention relates to data communication networks, and particularly to portals in an Internet environment.

2. Description of Related Art

Access to the Internet comes in many forms and guises. There is the “pure” Internet connection that just lets a user access the Internet and there are more complex varieties where the Internet Service Provider (ISP) also provides a kind of starting web page that a user “passes through” in order to get to the Internet proper. Such a web page, known as a portal, may for example provide one or more of news items, services such as search engines, advertisements, and links to other web sites. The portal as such is in some cases available only to the ISP's customers. An example of such a portal is America On-Line's (AOL's) starting page.

Other kinds of portals are not necessarily linked directly to an ISP, but still provide the above-mentioned content to users with Internet access. An example of this kind of portal is Yahoo® (www.yahoo.com) that is widely used by Internet users.

Some portals, for example “My Yahoo!”, provide the possibility to customize the content of the page to a certain degree by choosing the content among the provided content.

There are certain problems with the present day portals. A first problem is that these portals do not adjust themselves to the display capacities of the devices that are used, which means that a portal is displayed the same way on a large computer monitor as on a small mobile phone display.

A second problem is that the content is often limited to the content provided by the portal. The user is not at liberty to add information or services from other portals or web sites.

A third problem is that the portal does not follow the user. The portal may have a certain fixed address or it may show up automatically whenever the user goes through his ISP, but the flexibility is limited in either case.

A fourth problem is that the portal's content normally is independent of the context, i.e. the context is the same regardless of where the user is. This means that the same information will be received when the user temporarily moves from New York to Madrid, in which case the user for example would have to customise his portal to receive the local weather forecast.

The present invention seeks to overcome the shortcomings and problem of the prior art by providing a flexible, context dependent portal that the user can customise freely.

### SUMMARY OF INVENTION

The present invention is directed to a personal portal in a data communications network that comprises network entities. The personal portal is associated with a user and comprises a user profile, and at least one context profile.

The present invention is further directed to a method for updating profiles in a data communications network comprising a number of entities. Among these entities is a profile storage that stores profiles and for each profile a list of all on-line entities that store the profile. The method comprises the steps of updating the profile on an entity that sends the updated profile to the profile storage, which stores the updated profile. The profile storage then retrieves a list of all on-line entities that store the profile, and sends the updated profile to each entity on the retrieved list.

The present invention is further directed to a system for updating profiles in a data communications network comprising an entity that has updated a profile. The system comprises a profile storage and a number of on-line entities. The profile storage stores profiles and for each profile a list of all on-line entities that store the profile, receives the updated profile from the entity, stores the updated profile, retrieves a list of all on-line entities that store the profile, and sends the updated profile to each entity on the retrieved list. The on-line entities store the received profile.

The present invention is further directed to a profile storage in a data communications network that further comprises a number of entities that store at least part of a profile. The profile storage comprises a number of profiles and, for each profile, a list of entities that store the profile.

### BRIEF DESCRIPTION OF DRAWINGS

A more complete understanding of the present invention may be had by reference to the following Detailed Description when taken in conjunction with the accompanying drawings wherein

FIG. 1 depicts a block chart of an exemplary network environment in which the invention may be used;

FIG. 2 depicts a block chart of an exemplary embodiment of a personal portal according to the invention; and

FIG. 3 depicts a block chart illustrating synchronisation of a profile of a personal portal according to the invention.

### DETAILED DESCRIPTION

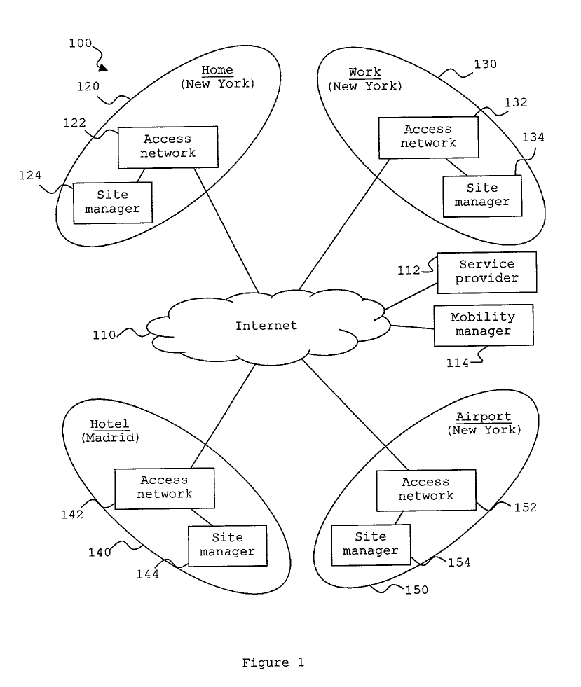

Reference is now made to the Drawings, wherein FIG. 1 depicts a block chart of an exemplary network environment in which the invention may be used. The network environment 100 comprises several areas or sites, a home site 120, a work site 130, a hotel site 140 and an airport site 150, interconnected by the Internet 110. It should be understood that the various sites technically may be said to belong to the Internet 110, but for the purposes of this description, the Internet 110 will comprise all the sites not specifically shown in FIG. 1.

Each of the sites comprises an access network 122, 132, 142 and 152 respectively and a site manager 124, 134, 144 and 154 respectively. The access network is the means of entry for a user desiring to access the network, regardless of access technology that for example could be some kind of cable connection or some kind of radio link. It is preferable if the access is achieved through a radio link, as this enables the user to be mobile. The site manager is among other things responsible for access rights within the site; a user connected through the hotel site's (140) access network (142) may for instance be denied access to film services other than the hotel's own film channels, while he may be allowed to listen to music no matter its origin.

When a user is connected through a certain site, i.e. when he accesses the site's access network, he is said to be in that specific context. In other words, when the user is at home (the home site 120) he is the Home context, when he is at work (the work site 130) he is in the Work context and so on. The various contexts will usually allow the user access to different kinds of information and different services that may be exclusive to users in the specific context, although information and services may in certain cases also be accessed from more than one context. For example, when the user is at work he may have access to confidential information that he may not have access to elsewhere, and when the user is at the airport he may be able to use a printer at the airport, something he may not be allowed to do from home.

The network 100 further comprises other network entities; such as a Service provider 112 and a Mobility manager 114 that are connected to the Internet 110. The Service provider 112 is an exemplary entity, external to the mentioned sites, that provides services to network users, sometimes in return for some payment. These services can be of many different kinds: stock tips, printing of photographs, selling books, governmental services and so on. The Mobility manager 114 is responsible for enabling users to move around in the network 100.

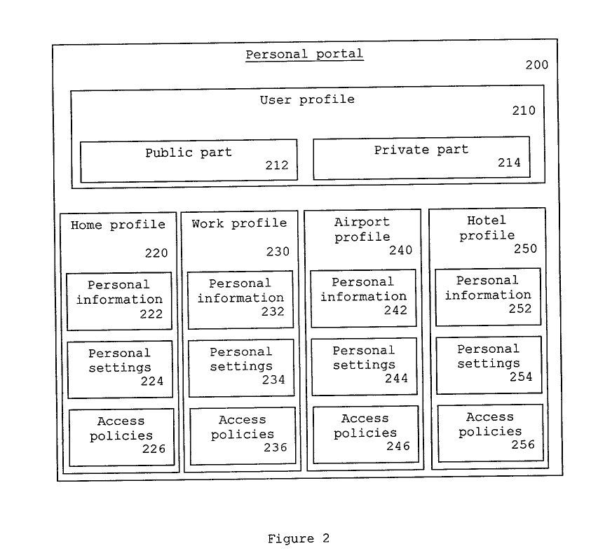

FIG. 2 illustrates a block chart of an exemplary embodiment of a personal portal according to the invention. The personal portal 200 comprises a user profile 210 and a number of contextual profiles, such as for example a home profile 220, a work profile 230, an airport profile 240 and a hotel profile 250.

The user profile 210 is independent of the user's current context and comprises information related to the user. The information is stored in either a public part 212 or a private part 214 of the user profile 210. The public part 212 comprises information accessible to the public, such as for example the user's favourite services, public personal information such as the user's phone number, and access policies for other users. The user may set the access rights for other users to this public part 212. The private part 214 comprises information normally accessible only to the user himself. This information may for example be an address book, phone numbers, and credit card numbers.

Each contextual profile 220, 230, 240 and 250 may comprise three parts: access policies 226, 236, 246 and 256, personal settings 224, 234, 244 and 254, and personal information 222, 232, 242 and 252. The access policies provide information on what the user is allowed to do within the context. This information can only be accessed and modified by the owner, i.e. usually the creator, or the administrator of the profile. The personal settings allow a user to customize the contextual profile, such as for example how the information is to be sent and displayed. When the contextual profile is created, default personal settings are used, but the user can later change these, even from outside the context, as the personal settings are accessible by the user both inside and outside the context. The personal information is optional. It can for example be used to store personal information that the user wants the administrator to be able to access. The information is accessible by both the administrator and the user, of which both have the right to add information.

The contextual profile 220, 230, 240 and 250 is only applicable within a certain context, contrary to the user profile 210 that always is applicable. The corresponding site manager (124, 134, 144, 154 in FIG. 1) normally stores contextual profiles. Another user or another contextual profile cannot share these profiles.

It is however possible to download a profile, or parts of a profile, to a device and more than one device can simultaneously store a version of a profile or parts of a profile. This may for example be the case with the user profile 210 or the personal information 222, 232, 242, 252 of a contextual profile 220, 230, 240, 250. The downloaded profiles may then be updated. When a profile is updated, that profile should, in most cases, be correspondingly updated on all the devices it is stored. This is to assure that each copy comprises information that is up-to-date.

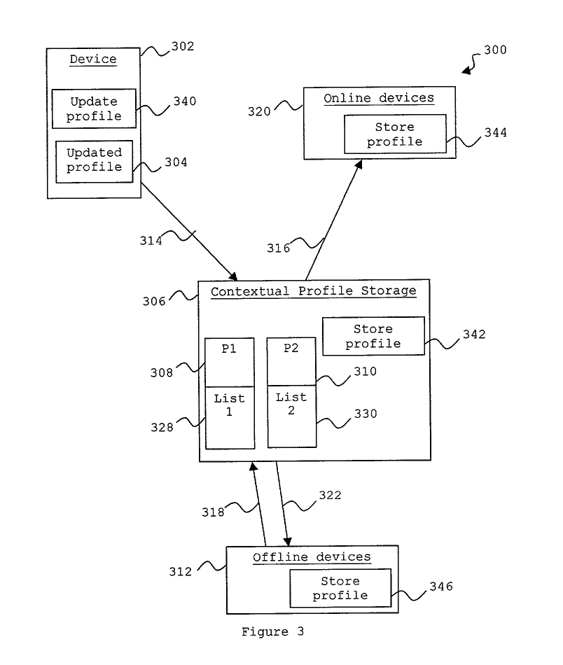

FIG. 3 depicts a block chart illustrating synchronisation of a profile of a personal portal according to the invention. In the network environment 300 is shown a device 302 on which a profile 304 that has been updated resides. There are further a contextual profile storage 306 storing a number of profiles 308, 310, a number of devices that are online 320, and a number of devices that are offline 312. It is assumed that the devices 312, 320 are devices that store a copy of, or are affected by, the profile that was updated by the device 302. The contextual profile storage 306 that normally is the owner of the profiles may reside within the site manager (e.g. 124 in FIG. 1), elsewhere within the site (e.g. 120 in FIG. 1) or be an external storage (not shown) available to more than one site. A person skilled in the art will appreciate that the contextual profile storage 306 in a real environment is likely to store many profiles.

Each time a user modifies a profile and saves the modifications, step 340, either the entire profile or, preferably, just the modifications, together with enough information to identify the profile, are sent in a message 314 to the contextual profile storage 306 that updates its stored profile that corresponds to the updated profile 304, step 342. The contextual profile storage 306 associates with each stored profile 308, 310 a list 328, 330 comprising the online devices 320 that store a copy of the profile.

Whenever the contextual profile storage 306 receives a message 314 with an updated profile, it retrieves from the relevant list 328, 330 the online devices 320 that store a copy of the profile, and sends a message 316 with the update to each of these devices 320.

When an offline device 312 goes online, it sends a request 318 to the contextual profile storage 306 asking for the modifications done to every profile the device 312 stores. The contextual profile storage 306 responds with one or more messages 322 comprising the updated profiles.

The devices then store the received profile, steps 344 or 346, and thus it is assured that all copies of a profile and the profile stored in the contextual profile storage are synchronised.

It should be understood that although the Portal is named a Personal Portal, it could be associated with any appropriate entity, such as for example a company, a family or a credit card.

Although several preferred embodiments of the methods, systems and nodes of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

1. A personal portal in a data communications network that comprises network entities, the personal portal being associated with a user and comprising:
a user profile; and
at least one context profile.

2. The personal portal of claim 1, wherein the user profile comprises a private part that is accessible only to the user.

3. The personal portal of claim 1, wherein the user profile comprises a public part that is accessible by at least one other network entity.

4. The personal portal of claim 1, wherein the at least one context profile comprises personal information associated with the user.

5. The personal portal of claim 1, wherein the at least one context profile comprises personal settings.

6. The personal portal of claim 5, wherein the personal settings comprise information on how information is to be sent.

7. The personal portal of claim 5, wherein the personal settings comprise information on how information is to be displayed.

8. The personal portal of claim 1, wherein the at least one context profile comprises access policies associated with the user.

9. The personal portal of claim 1, wherein the data communications network further comprises at least one site, and each context profile is related to a site.

10. The personal portal of claim 9, wherein the context profile is stored within the site.

11. The personal portal of claim 9, wherein the site comprises an access network and the context profile is available only within that access network.

12. A method for updating profiles in a data communications network comprising a number of entities, among them a profile storage that stores profiles and for each profile a list of all on-line entities that store the profile, the method comprising the steps of:
updating the profile on an entity;
sending the updated profile from the entity to the profile storage;
storing the updated profile by the profile storage;
retrieving by the profile storage a list of all on-line entities that store the profile; and
sending the updated profile to each entity on the retrieved list.

13. The method for updating profiles of claim 12 further comprising the steps of:
sending from an entity that has gone on-line to the profile storage, a request for modifications done to profiles the entity stores; and
sending from the profile storage to the entity that has gone on-line the requested profiles.

14. A system for updating profiles in a data communications network comprising an entity that has updated a profile, the system comprising:
a profile storage and a number of on-line entities, wherein
the profile storage:
stores profiles and for each profile a list of all on-line entities that store the profile;
receives the updated profile from the entity;
stores the updated profile;
retrieves a list of all on-line entities that store the profile; and
sends the updated profile to each entity on the retrieved list; and
the on-line entities:
store the received profile.

15. The system for updating profiles of claim 14, the system further comprising an entity that has gone on-line that:
sends a request for modifications done to profiles the entity stores; and
stores received profiles; and
the profile storage further:
receives the request; and
sends to the entity that has gone on-line the requested profiles.

16. A profile storage in a data communications network that further comprises a number of entities that store at least part of a profile, the profile storage comprising a number of profiles and, for each profile, a list of entities that store the profile.
